(19) United States
(12) Patent Application Publication
(10) Pub. No.: US 2020/0113648 A1
(43) Pub. Date: Apr. 16, 2020

(54) ENDODONTIC INSTRUMENT

(71) Applicant: Wojciech PAWLOWSKI, Stalowa Wola (PL)

(72) Inventor: Wojciech PAWLOWSKI, Stalowa Wola (PL)

(21) Appl. No.: 16/585,796

(22) Filed: Sep. 27, 2019

(30) Foreign Application Priority Data
Oct. 15, 2018 (PL) P.427406

(51) Int. Cl. A61C 5/46

(52) U.S. Cl. CPC A61C 5/46

(57) ABSTRACT

An endodontic instrument comprises three principal parts: a sleeve-shaped housing (1) one end of which is closed with a nut (2) provided with a straight-through hole; a movable bolt (3) situated axially in the housing (1); and a replaceable working nosepiece with a coupling attachment (4) to which, at the other end of the housing (1), permanently joined is a cannula (5) with the diameter of 0.30-0.35 mm inside which two thin wires with the diameter of 0.07-1.5 mm are placed to form a loop (6) outside the cannula (5), said wires being joined permanently with each other outside the attachment (4) with the use of a fastener (7). The housing (1) has, on its side surface and in its portion adjacent to the working nosepiece, a longitudinal slit (8) is provided with a width exceeding slightly the thickness of the wire which, on a portion of its length, has a recess (9) with a size exceeding slightly the size of the fastener (7), and the a movable bolt (3), on its working nosepiece side, has a properly shaped groove (10) with a shape analogous to this of the longitudinal slit (8) in the housing (1), in which there are ends of the wire fastened in a fastener (7). The fastener (7) is further situated in a widened portion of the groove (10) provided in the bolt (3) with a screw (11) screwed into opposite side of the bolt (3) for provisional adjustment of position of the bolt (3) with a knob protruding outside the nut (2) screwed onto end portion of the housing (1), whereas there is a spring (13) between the nut (2) and a seat (12) formed on the bolt (3). Side surface of the housing (1) is provided with a longitudinal recess (14) for a screw (15) used to move the bolt (1) manually and thus to draw the wire loop (6), said screw being screwed into a threaded hole provided in the bolt (3) perpendicularly to its axis.

### FIELD OF THE INVENTION

The subject of the invention is an endodontic instrument designed especially for retrieving fragments of broken root canal procedure tools from tooth root canals.

### BACKGROUND

In the course of the root canal procedure, tools used for this purpose are frequently subject to breakage, and removing such tool fragments from a root canal poses a serious problem, especially in case of curved canals. To retrieve such tool fragments, it is sometimes necessary to ream the dentine which weakens the treated tooth significantly. Relatively often a broken tool fragment used to be left in the root canal which was subsequently filled with a stabilising material. In the dental treatment practice, known are various types of tools and instruments for retrieving fragments of broken tools used for the root canal procedure. For instance, description of invention from patent application No. P.411504 discloses an endodontic instrument for removing fragments of broken instruments from tooth root canals, which comprises: an ergonomic handle; a body with spring-loaded mechanism activated by means of a ratchet lever; and an adequately thin profiled working part bent at an angle relative to the handle and the body. The working part comprises two elements situated one within another and co-operating one with another. The first element is a tube with a cut-out in its side wall situated in the vicinity of its distal end, and the second element a movable reciprocating piston or bolt with a conical tip situated inside the bore of the tube. According to the invention, the tube constituting the first element of the working part of the device is, in its proximal portion, joined permanently with the body, and in the vicinity of its distal end has two cut-outs situated opposite each other and thus forming a straight passage through the bore or the inner space of the tube, whereas the movable bolt has a sharp tip in the form of an arrowhead and is coupled with a bolt pull-out mechanism comprising a recoil sprig and activated by means of the ratchet lever. The solution according to the application P.411504 is in practice virtually useless for removing fragments of broken tools from curved root canals; moreover it requires that a large hole must be drilled in the treated tooth which results in significant weakening of the treated tooth. An increasing popularity is observed of devices enabling to lasso a broken tool fragment left in tooth canal with the use of a loop formed of a thin wire. One such device developed recently is a tool named FragRemover. The tool comprises an ergonomic gun-shaped handle with a tube situated at the end of the handle, in which a loop of thin wire is situated. A ring situated on the handle can be turned to draw the loop around the retrieved tool fragment. Further, patent description of application DE 102013009483 (A1) discloses a device with the same scope of application which has a thin wire in the form of a loop situated an a slim hollow needle, whereas wire ends are anchored in a plastic body which is fixed in a hollow cylinder. The wire loop is tightened with the use of a tightening device which comprises a springy sleeve, an adjusting sleeve, and a blocking portion. From description of the utility model DE 202012011309 (U1) known is a device for removing broken tools from tooth root canals with the use of a modified wire loop which is characterised in that a thin (0.05 mm) wire is threaded through two thin needles welded with each other, and ends of the wire are anchored in a cylinder. The wire forms a loop outside the front end of the welded needles. The wire loop can be replaced and tightened with the use of a tightening device comprising an adjustment sleeve and a locking part. Known is also a device invented by by Dr. Yoshi Terauchi and presented on a website with the address htttps://www.youtube.com/watch?v=nDJ8m-XIVLs comprising a cylindrical handle terminated with a needle in which a thin wire is situated forming a loop at the needle outlet, drawn on the broken tool fragment by means of a slide. Recently, a website named endocowboy.com has published information about an instrument named Endocowboy developed by Denis Kohrer and designed for removing fragments of broken tools used for dental canal treatment from tooth root canals, said instrument having a replaceable working nosepiece with deformable needle with the diameter of 0.4 mm, in which a wire is situated with the diameter of 0.1 mm to form a loop outside the needle. The replaceable nosepiece is fixed at the end of tube-shaped housing terminated with a nut on the other end, while the other end of the wire is drawn, as it can be deduced by analysing sketches of the instrument posted on the above-quoted website, clamped by means of a screw driving a slide situated in the housing.

A shortcoming of the known devices is their relatively low operational effectiveness. The tightening of the thin wire loop in the FragRemover on broken fragment of a tool for root canal treatment is entirely random and moreover, requires that another device is to be used for the next attempt to retrieve the broken tool, which increases the treatment cost significantly. In turn, although the instrument named Endocowboy allows to use the instrument repeatedly by replacing the tightened loop with a new one, it still does not allow to the working nosepiece repeatedly and moreover, the method of fixing the wire in the housing seems to be too complicated.

### SUMMARY

The objective of the present invention is to provide a structure for an endodontic instrument intended for retrieving broken fragments of root canal procedure tools with high operational effectiveness, also in cases when a broken tool fragment got stuck in a curved root canal, and moreover, inexpensive and easy to operate.

The endodontic instrument, comprising a sleeve-shaped housing terminated, on one end, with a nut and on the other end, with a replaceable working nosepiece with a cannula, in which a thin wire is situated forming a loop outside the cannula and equipped with a loop tightener, according to the subject-matter of the invention, comprises three principal parts: a sleeve-shaped housing one end of which is closed with a nut provided with a straight-through hole; a movable bolt situated axially in the housing; and fixed, on properly shaped other end of the housing, a replaceable working nosepiece with a coupling attachment, to which permanently joined is a cannula with the diameter of 0.30-0.35 mm inside which two thin wires with the diameter of 0.07-1.5 mm made of Nitinol are placed, said wires forming a loop outside the cannula mouth and being joined permanently with the use of a fastener outside the attachment. Side surface of the housing, at its working nosepiece end, is provided with a longitudinal slit the width of which slightly exceeds the thickness of the wire, which on a portion of its length has a recess the size of which exceeds slightly the size of the fastener, and the movable bolt on the working nosepiece side has a properly shaped groove with a shape analogous to this of the longitudinal slit in the housing. In the groove provided in the bolt there are ends of the wire fastened in a fastener, and the fastener itself is moreover situated in a widened portion of the groove of the bolt. The other end of the bolt is provided with a screw for preliminary adjustment of position of the bolt with a knob protruding outside the nut screwed onto the housing end, whereas a spring is provided between the nut and a set formed on the bolt. Side surface of the housing is provided with a longitudinal recess for a screw used to move the bolt manually and thus to draw the wire loop, said screw being screwed into a threaded hole provided in the bolt perpendicularly to its axis. Preferably, onto a thread provided on side surface of the housing above the longitudinal slit with the screw used to move the bolt manually, a nut of a stopper limiting motion of the bolt upwards is screwed. Also preferably, the wire is made of Nitinol. Additionally and preferably, the cannula of the replaceable attachment may be rectilinear with an option to adapt its shape arbitrarily. In a variant of embodiment, the wire loop is formed outside a hole provided in side surface of the cannula, in the vicinity of its closed tip. In another embodiment variant, the wire loop is situated between two holes provided in side surface of the cannula, in the vicinity of its blindly closed tip. In still another embodiment variant, the wire loop is formed between a hole provided in side surface of the cannula, in the vicinity of its tip, and another hole provided in the cannula tip.

Such structure of the endodontic instrument ensures its operating effectiveness and allows to replace easily the working nosepiece with a new one which results in reduction of the overall treatment cost. Moreover, the working nosepiece with a wire loop formed between two holes provided on side surface of the cannula or between a hole on side surface of the cannula and a hole provided in its tip offers the possibility to use the same cannula repeatedly.

### BRIEF DESCRIPTION OF THE DRAWINGS

The subject of the invention is illustrated in drawings, of which:

FIG. 1 shows the endodontic instrument with rectilinear cannula in the axonometric projection;

FIG. 2 shows the endodontic instrument without its working portion in axial section;

FIGS. 3-5 show schematic views of the tip of the cannula fixed in the working nosepiece, in consecutive variants of embodiment; and

FIG. 6 shows the working nosepiece with rectilinear cannula.

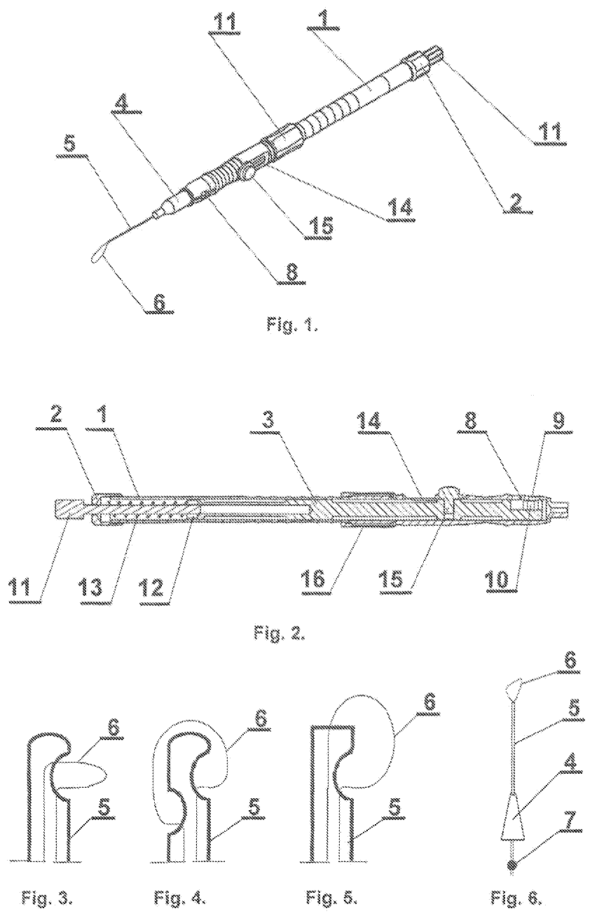

### DETAILED DESCRIPTION

The subject of the invention is presented in the following in its example embodiments.

### Example 1

The endodontic instrument comprises three principal parts: a sleeve-shaped housing 1 one end of which is closed with a nut 2 provided with a straight-through hole; a movable bolt 3 situated axially in the housing 1; and a replaceable working nosepiece with a coupling attachment 4, fixed on properly shaped other end of the housing 1, to which permanently joined is a cannula 5 with the diameter of 0.35 mm inside which two thin Nitinol wires with the diameter of 0.15 mm are placed forming a loop 6 outside mouth of the cannula 5 and joined with each other with the use of a fastener 7 outside the attachment 4. Side surface of the housing 1 has, at its working nosepiece end, a longitudinal slit 8 with the width exceeding slightly the thickness of the wire, which on a portion of its length has a recess 9 with a size exceeding slightly the size of the fastener 7, whereas the movable bolt 3 has, on its working nosepiece side, a properly shaped groove 10 with a shape analogous to this of the longitudinal slit 8 in the housing 1. In the groove 10 provided in the bolt 3 there are ends of the wire fastened in a fastener 7, and the fastener 7 itself is moreover situated in a widened portion of the groove 10 made in the bolt 3. On the opposite side, a screw 11 is screwed into the bolt 3 for provisional adjustment of position of the bolt 3 with a knob protruding outside the nut 2 screwed onto end portion of the housing 1, whereas there is a spring 13 between the nut 2 and a seat 12 formed on the bolt 3. Side surface of the housing 1 is provided with a longitudinal recess 14 for a screw 15 used to move the bolt 1 manually and thus to draw the wire loop 6, said screw being screwed into a threaded hole provided in the bolt 3 perpendicularly to its axis. Onto a thread provided on side surface of the housing 1 above the recess 14, a nut 16 is screwed limiting the travel of the bolt 3 upwards.

### Example 2

In a housing 1 with a bolt 3 with structure the same as in Example 1, a working nosepiece with a cannula 5 with the diameter of 0.30 mm is fixed with the use of a coupling attachment 4, whereas a loop 6 of Nitinol wire with the diameter of 0.08 mm formed outside a hole provided in side surface of the cannula 5, in the vicinity of its blindly closed tip.

### Example 3

In a housing 1 with a bolt 3 with structure the same as in Example 1, a working nosepiece with a cannula 5 with the diameter of 0.33 mm is fixed with the use of a coupling attachment 4, whereas a loop 6 of Nitinol wire with the diameter of 0.1 mm situated between two holes provided in side surface of the cannula 5, in the vicinity of its blindly closed tip.

### Example 4

In a housing 1 with a bolt 3 with structure the same as in Example 1, a working nosepiece with a cannula 5 with the diameter of 0.35 mm is fixed with the use of a coupling attachment 4, whereas a loop 6 of Nitinol wire with the diameter of 1.1 mm formed between a hole provided in side surface of the cannula 5 in the vicinity of its tip and a hole provided at the end of the cannula 5.

1. An endodontic instrument having a sleeve-shaped housing terminated, on one end, with a nut, and on the other end, with a replaceable working nosepiece with a cannula in which a thin wire is situated forming a loop outside the cannula and equipped with a loop tensioner, characterised in that it comprises three principal parts: a sleeve-shaped housing (1) one end of which is closed with a nut (2) provided with a hole; a movable bolt (3) situated in the housing (1) on its axis; and a replaceable working nosepiece with a coupling attachment (4) fixed on properly shaped other end of the housing (1) to which permanently fixed is a cannula (5) with the diameter of 0.30-0.35 mm inside which two thin wires with the diameter of 0.07-1.5 mm are placed forming a loop (6) outside mouth of the cannula (5) and joined with each other with the use of a fastener (7) outside the attachment (4), whereas side surface of the housing (1) is provided, at its working nosepiece end, a longitudinal slit (8) with the width exceeding slightly the thickness of the wire, with a portion of the length of said slit having a recess (9) with a size exceeding slightly the size of the fastener (7), and the a movable bolt (3), on its working nosepiece side, has a properly shaped groove (10) with the shape analogous to this of the longitudinal slit (8) in the housing (1), in which there are ends of the wire fastened in a fastener (7), and the fastener (7) itself is moreover situated in a widened portion of the groove (10) of the bolt (3), with a screw (11) screwed into opposite side of the bolt (3) for provisional adjustment of position of the bolt (3) and with a knob protruding outside the nut (2) screwed onto end portion of the housing (1), whereas there is a spring (13) between the nut (2) and a seat (12) formed on the bolt (3), and moreover, side surface of the housing (1) is provided with a longitudinal recess (14) for a screw (15) used to move the bolt (1) manually and thus to draw the wire loop (6), said screw being screwed into a threaded hole provided in the bolt (3) perpendicularly to its axis.

2. The instrument according to claim 1 characterised in that onto a threat provided in side surface of the housing (1) above the longitudinal recess (14) for the screw (15) used to move manually the bolt (3), a nut (16) is screwed limiting the travel of the bolt (3) upwards.

3. The instrument according to claim 1 characterised in that the wire is made of Nitinol.

4. The instrument according to claim 1 characterised in that the cannula (5) of the replaceable attachment with an option to adapt its shape arbitrarily.

5. The instrument according to claim 1 characterised in that the wire loop (6) is formed outside a hole provided in side surface of the cannula (5), in the vicinity of its blindly closed tip.

6. The instrument according to claim 1 characterised in that the wire loop (6) is formed between two holes provided in side surface of the cannula (5) in the vicinity of its blindly closed tip.

7. The instrument according to claim 1 characterised in that the wire loop (6) is formed between a hole provided in side wall of the cannula (5) in the vicinity of its tip and a hole provided at the end of the cannula (5).
